(19) United States
(12) Patent Application Publication
(10) Pub. No.: US 2019/0026762 A1
(43) Pub. Date: Jan. 24, 2019

(54) SYSTEM AND METHOD FOR RETAIL PRICING WITHIN PRODUCT LINKAGES

(71) Applicant: Tata Consultancy Services Limited, Mumbai (IN)

(72) Inventors: Hari RAGURAMAN, Chennai (IN); Hariharan SURYANARAYANAN, Chennai (IN)

(73) Assignee: Tata Consultancy Services Limited, Mumbai (IN)

(21) Appl. No.: 16/068,855

(22) PCT Filed: Jan. 6, 2017
(86) PCT No.: PCT/IB2017/050054

§ 371 Date: Jul. 9, 2018

(30) Foreign Application Priority Data
Jan. 8, 2016 (IN) 201621000831

(51) Int. Cl. G06Q 30/02

(52) U.S. Cl. CPC G06Q 30/0206

(57) ABSTRACT

System and method for retail pricing within product linkages are disclosed. In an embodiment, a ranking criteria defined for items in a product linkage and predefined business rules are received. The product linkage includes a set of items linked to each other. Further, the items in the product linkage are ranked based on the ranking criteria defined for the items. Furthermore, a retail price of an item is compared with a retail price of linked items in the product linkage, in an order of the ranks, based on the predefined business rules. Moreover, retail price tolerance limits of the item are computed based on saving ranges between the item and linked items upon comparison. In addition, the retail price of the item in the product linkage is updated based on the computed retail price tolerance limits.

### CROSS REFERENCE TO RELATED APPLICATIONS AND PRIORITY

The present invention claims priority to Indian Provisional specification (Title: System and method for retail pricing within product linkages) No. 201621000831, filed in India on Jan. 8, 2016.

### TECHNICAL FIELD

The embodiments herein generally relate to product linkages and, more particularly, to retail pricing based on ranking and order within the product linkages.

### BACKGROUND

Generally, in retail, pricing is performed by retailers at individual item level. The conventional approach later evolved to grouping of items based on similarity of attributes and then pricing items within grouping based on pricing key items within the grouping. The approach enabled to efficiently price millions of items in a catalog. However, the approach may not consider other factors that govern pricing of items, e.g., elasticity, brand type and unit of measure (UOM) savings convergence, psychological rounding and so on. In the approach, retail alignment based on product linkages is applied after recommending retail based on competitive captures. However, the linkage based retail recommendation may be seldom intuitive to the end users to follow trace. The process of alignment also is manual in cases where savings recommended by competing linkages (UOM and brand based linkages) do not overlap. Also, the approach may need a lot attention and time from the end user in order to set appropriate prices for items in a linkage at a zone level.

### SUMMARY

The following presents a simplified summary of some embodiments of the disclosure in order to provide a basic understanding of the embodiments. This summary is not an extensive overview of the embodiments. It is not intended to identify key/critical elements of the embodiments or to delineate the scope of the embodiments. Its sole purpose is to present some embodiments in a simplified form as a prelude to the more detailed description that is presented below.

In view of the foregoing, an embodiment herein provides methods and systems for retail pricing with product linkages are disclosed. In one aspect, a processor-implemented method includes steps of: receiving, by one or more hardware processors, a ranking criteria defined for items in a product linkage and predefined business rules, wherein the product linkage comprises a set of items linked to each other; ranking, by the one or more hardware processors, the items in the product linkage based on the ranking criteria defined for the items; comparing, by the one or more hardware processors, a retail price of an item with a retail price of linked items in the product linkage, in an order of the ranks, based on the predefined business rules; computing, by the one or more hardware processors, retail price tolerance limits of the item based on saving ranges between the item and linked items upon comparison; and updating, by the one or more hardware processors, the retail price of the item in the product linkage based on the computed retail price tolerance limits. In some embodiments, the method includes updating at least one of saving ranges recommended by the size link and the brand link of an item when at least one of a retail price of the item is beyond associated retail price tolerance limits compared with associated linked items and the retail price of the item is a new retail price.

In another aspect, a system for activity detection from metadata features of e-mails is provided. The system includes one or more memories; and one or more hardware processors, the one or more memories coupled to the one or more hardware processors wherein the one or more hardware processors are capable of executing programmed instructions stored in the one or more memories to: receive a ranking criteria defined for items in a product linkage and predefined business rules, wherein the product linkage comprises a set of items linked to each other; rank the items in the product linkage based on the ranking criteria defined for the items; compare a retail price of an item with a retail price of linked items in the product linkage, in an order of the ranks, based on the predefined business rules; compute retail price tolerance limits of the item based on saving ranges between the item and linked items upon comparison; and update the retail price of the item in the product linkage based on the computed retail price tolerance limits. In some embodiments, the one or more hardware processors are further capable of executing programmed instructions to update at least one of saving ranges recommended by the size link and the brand link of an item when at least one of a retail price of the item is beyond associated retail price tolerance limits compared with associated linked items and the retail price of the item is a new retail price.

In yet another aspect, a non-transitory computer-readable medium having embodied thereon a computer program for executing a method for activity detection from metadata features of e-mails. The method includes steps of: receiving, by one or more hardware processors, a ranking criteria defined for items in a product linkage and predefined business rules, wherein the product linkage comprises a set of items linked to each other; ranking, by the one or more hardware processors, the items in the product linkage based on the ranking criteria defined for the items; comparing, by the one or more hardware processors, a retail price of an item with a retail price of linked items in the product linkage, in an order of the ranks, based on the predefined business rules; computing, by the one or more hardware processors, retail price tolerance limits of the item based on saving ranges between the item and linked items upon comparison; and updating, by the one or more hardware processors, the retail price of the item in the product linkage based on the computed retail price tolerance limits. In some embodiments, the method includes updating at least one of saving ranges recommended by the size link and the brand link of an item when at least one of a retail price of the item is beyond associated retail price tolerance limits compared with associated linked items and the retail price of the item is a new retail price.

It should be appreciated by those skilled in the art that any block diagram herein represents conceptual views of illustrative systems embodying the principles of the present subject matter. Similarly, it is appreciated that any flow charts, flow diagrams, state transition diagrams, pseudo code, and the like represent various processes which may be substantially represented in computer readable medium and so executed by a computing device or processor, whether or not such computing device or processor is explicitly shown.

### BRIEF DESCRIPTION OF THE FIGURES

The detailed description is described with reference to the accompanying figures. In the figures, the left-most digit(s) of a reference number identifies the figure in which the reference number first appears. The same numbers are used throughout the drawings to reference like features and modules.

FIG. 1 illustrates a system for retail pricing within product linkages, according to an embodiment of a present subject matter;

FIG. 2 is a diagram illustrating a scenario for retail pricing based on ranking and order within a product linkage, according to an embodiment of a present subject matter; and

FIG. 3 illustrates a flow diagram of a method for activity detection from metadata features of e-mails, in accordance with an example embodiment.

It should be appreciated by those skilled in the art that any block diagrams herein represent conceptual views of illustrative systems and devices embodying the principles of the present subject matter. Similarly, it will be appreciated that any flow charts, flow diagrams, and the like represent various processes which may be substantially represented in computer readable medium and so executed by a computer or processor, whether or not such computer or processor is explicitly shown.

### DETAILED DESCRIPTION

The embodiments herein and the various features and advantageous details thereof are explained more fully with reference to the non-limiting embodiments that are illustrated in the accompanying drawings and detailed in the following description. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The terms “item” and “product” are used interchangeably throughout the document.

The present technique serves as an accelerator in pricing large volumes of items that are related to one another by means of comparable attributes and have been grouped as product linkages. The technique deals with assessing items within a linkage, ranking the items and cascade retail calculations based on the ranking. The technique leverages the current competitor pricing process of identifying key items that are shopped across competitor doors and priced according to a predefined competitor strategy. Retail originates from the key items that get the retail recommendation from the competitive strategy and trickles onto linked items based on rankings and competitor priority. Thus providing automatic adjustment of savings percentage amongst linked items based on changing competitor trend and enabling retailers to stay abreast with competitor changes with zero manual intervention. Also, the technique prioritizes competitor capture over internal ranking and savings based on weightage within a link and linkage type. The present technique also provides details on the state of savings within the linkage before and after applying a dynamic rule for retail recommendation. For example, the above technique is implemented on Big data platform which enables achieving reliability and performance.

The methods and systems are not limited to the specific embodiments described herein. In addition, the method and system can be practiced independently and separately from other modules and methods described herein. Each device element/module and method can be used in combination with other elements/modules and other methods.

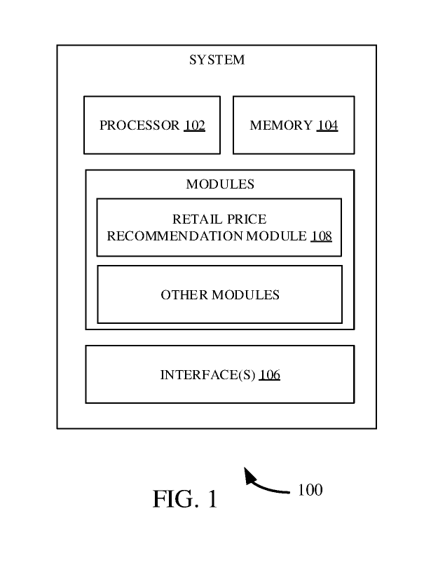

The manner, in which the system and method for retail pricing within product linkages, has been explained in details with respect to the FIGS. 1 through 3. While aspects of described methods and systems for retail pricing within product linkages can be implemented in any number of different systems, utility environments, and/or configurations, the embodiments are described in the context of the following exemplary system(s).

FIG. 1 illustrates a block diagram of a system 100 for retail pricing within product linkages, in accordance with an example embodiment. In an example embodiment, the system 100 may be embodied in, or is in direct communication with a computing device. The system 100 includes or is otherwise in communication with one or more hardware processors such as processor(s) 102, one or more memories such as a memory 104, and a network interface unit such as a network interface unit 106. In an embodiment, the processor 102, memory 104, and the network interface unit 106 may be coupled by a system bus such as a system bus or a similar mechanism. Although FIG. 1 shows example components of the system 100, in other implementations, the system 100 may contain fewer components, additional components, different components, or differently arranged components than depicted in FIG. 1.

The processor 102 may include circuitry implementing, among others, audio and logic functions associated with the communication. For example, the processor 102 may include, but are not limited to, one or more digital signal processors (DSPs), one or more microprocessor, one or more special-purpose computer chips, one or more field-programmable gate arrays (FPGAs), one or more application-specific integrated circuits (ASICs), one or more computer(s), various analog to digital converters, digital to analog converters, and/or other support circuits. The processor 102 thus may also include the functionality to encode messages and/or data or information. The processor 102 may include, among other things, a clock, an arithmetic logic unit (ALU) and logic gates configured to support operation of the processor 102. Further, the processor 102 may include functionality to execute one or more software programs, which may be stored in the memory 104 or otherwise accessible to the processor 102.

The functions of the various elements shown in the figure, including any functional blocks labeled as “processor(s)”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation DSP hardware, network processor, application specific integrated circuit (ASIC), FPGA, read only memory (ROM) for storing software, random access memory (RAM), and non-volatile storage. Other hardware, conventional, and/or custom, may also be included.

The interface(s) 106 may include a variety of software and hardware interfaces, for example, interfaces for peripheral device(s), such as a keyboard, a mouse, an external memory, and a printer. The interface(s) 106 can facilitate multiple communications within a wide variety of networks and protocol types, including wired networks, for example, local area network (LAN), cable, etc., and wireless networks, such as Wireless LAN (WLAN), cellular, or satellite.

The one or more memories such as a memory 104, may store any number of pieces of information, and data, used by the system to implement the functions of the system. The memory 104 may include for example, volatile memory and/or non-volatile memory. Examples of volatile memory may include, but are not limited to volatile random access memory. The non-volatile memory may additionally or alternatively comprise an electrically erasable programmable read only memory (EEPROM), flash memory, hard drive, or the like. Some examples of the volatile memory includes, but are not limited to, random access memory, dynamic random access memory, static random access memory, and the like. Some example of the non-volatile memory includes, but are not limited to, hard disks, magnetic tapes, optical disks, programmable read only memory, erasable programmable read only memory, electrically erasable programmable read only memory, flash memory, and the like. The memory 104 may be configured to store information, data, applications, instructions or the like for enabling the system 100 to carry out various functions in accordance with various example embodiments. Additionally or alternatively, the memory 104 may be configured to store instructions which when executed by the processor 102 causes the system to behave in a manner as described in various embodiments. The memory 104 includes a retail price recommendation module 108 and other modules. The module 108 and other modules include routines, programs, objects, components, data structures, etc., which perform particular tasks or implement particular abstract data types. The other modules may include programs or coded instructions that supplement applications and functions of the system 100.

In operation, the retail price recommendation module 108 provides accurate recommendation of retail price for items in a product linkage when one or more items within the linkage undergoes a retail change due to an external trigger, for example, a competitor price change. For example, product linkages are created for items in consideration with appropriate CAP defined for %/$ retail change (e.g., threshold). The product linkage may include a set of items linked to each other. The retail price recommendation module 108 reviews each item in the linkage one by one against the item's immediately adjoining linked items to level set the retails based on a set ranking and underlying business rules.

In an embodiment, the retail price recommendation module 108 receives a ranking criteria defined for items in a product linkage and predefined business rules. The ranking criteria may include one or more of key value indicators, brand type (e.g., store brand, national brand etc.,) size (smaller size always wins), color, font and sensitivity of each of the item in the product linkage. For example, the business rules are rules based on which items cannot drive the neighbors and savings get recalculated based on the capture retails. In this example, the business rules are defined at the sales organization level to enable a further layer of validation and robustness. The rules include KVI items' permissions to drive retail at lower level(s) or same level defined strongly based on business intent, prioritization of competitor strategy over defined ranking when multiple items in the linkage are shopped and so on. Also, rounding is defined for linkage rules to fall back to.

Further, the retail price recommendation module 108 ranks items in the linkage based on the ranking criteria defined for the items. In an example, the ranking of the items within the linkage may vary by a zone, a category, a brand type and the like. Thus providing flexibility to adjust rankings by each of the aforesaid variants.

Furthermore, the retail price recommendation module 108 compares a retail price of an item with a retail price of linked items in the product linkage, in an order of the ranks, based on the predefined business rules. In other words, if an item does not have a new retail price, the retail price recommendation module 108 compares the current retail price against the retail (current or new) of the immediate neighbors (brand linked or unit of measure (UOM) (i.e., size) linked) for verifying the retail price and associated saving ranges are correct with respect to the linked items.

In addition, the retail price recommendation module 108 computes retail price tolerance limits of the item based on saving ranges between the item and linked items upon comparison. For example, the saving ranges are recommended by one or more of a size link and a brand link between the item and linked items in the product linkage. Moreover, the retail price recommendation module 108 updates the retail price of the item in the product linkage based on the computed retail price tolerance limits. In an example embodiment, the retail price recommendation module 108 computes a first retail price tolerance limit between a size linked first item (A) and second item (B) and a second retail price tolerance limit between a brand linked second item (B) and third item (C) when the first item (A) ranking drives retail changes to the second item (B), the second item (C) is linked to the third item (C) in a complimentary link, and the third item (C) received a retail change. Further in this example embodiment, the retail price recommendation module 108 updates a retail price of the second item based on an overlapping tolerance limit between first retail price tolerance limit and second retail price tolerance limit. For example, the overlapping tolerance limit is obtained based on minimum and maximum values in the first retail price tolerance limit and second retail price tolerance limit. In other words, the overlapping tolerance limit (overlap savings) includes a lower limit as Max (lower tolerance savings of the 2 links) and an upper limit as Min (Upper tolerance savings of the 2 links).

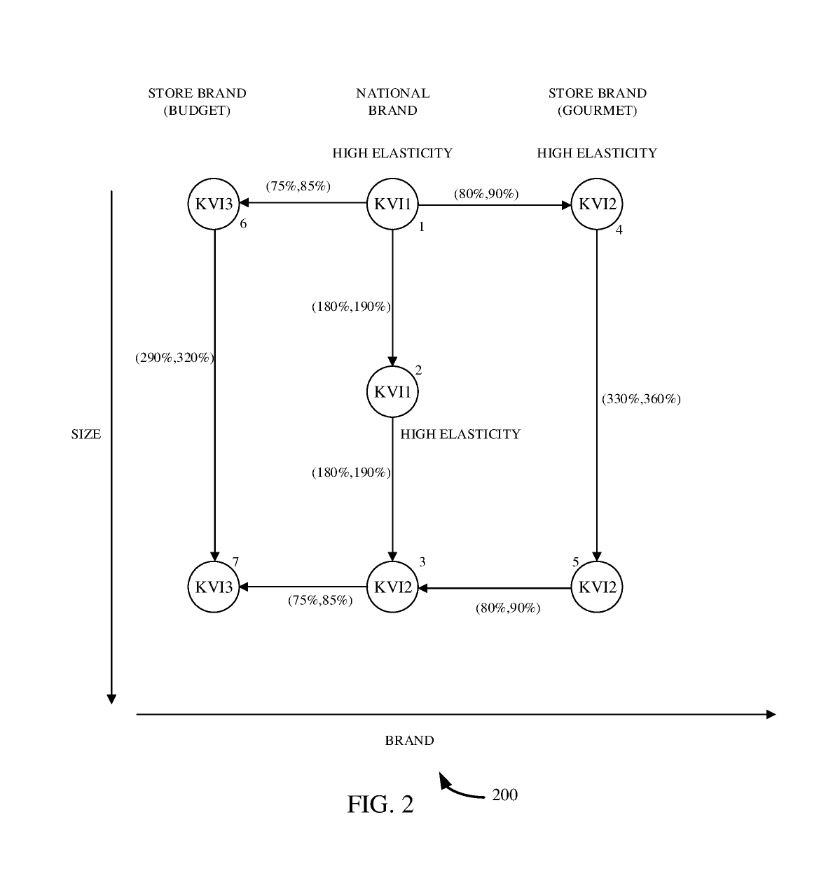

In an example embodiment, the retail price recommendation module 108 holds the retail price recommendation when an item (A) cannot drive retail price change to its adjoining linked item (B) if the item B is linked to another item (C) that has a higher rank than B and has not received a retail change. The item B receives the retail change when C gets its turn. This is explained in more detailed with reference to FIG. 2.

In another example embodiment, the retail price recommendation module 108 updates a retail price of an item based on no overlap savings. In an example, an item X is part of a UOM Link as well as a brand link. The item X has brand linkage with an item ranked higher than the item to which item X is linked by the UOM. There is no overlap between savings range recommended by the brand link and UOM link By virtue of linkage to a higher ranked item, brand savings recommendation wins and the item X is accordingly aligned. Alert is then generated with recommendation for new UOM savings. For example, retail price of size driven item (A) is $1.69, retail price of a brand driven item (B) is $3.29 and retail price of target item (X) is $2.39. Further, retail price tolerance limits computed based on savings (15%, 25%) between A and X is ($2.49, $2.79) and retail price tolerance limits computed based on savings (5%, 10%) between B and X is ($2.99, $3.19). Here, there is no overlapping between the tolerance limits. Hence, the retail price of the item X is updated to lower limit of the brand tolerance limits ($2.49) and saving ranges between item A and item X are updated to (15%, 20%).

In yet another example embodiment, the retail price recommendation module 108 updates one or more of saving ranges recommended by the size link and the brand link of an item when at least one of a retail price of the item is beyond associated retail price tolerance limits compared with associated linked items and the retail price of the item is a new retail price.

In some embodiments, the retail price recommendation module 108 performs elasticity driven retail recommendation. In these embodiments, when the KVI for items is auto recommended by a competitor pricing system and elasticity is one of a key parameters in determining the KVI, the retail price recommendation module 108 performs elasticity driven retail recommendation. If two or more items with in a linkage are shopped and retail recommendation is based on elasticity rules within a competitive strategy, then linkage rules yield and auto adjust the savings percentages defined for the items to retain the retail recommended by the competitor strategy. Thus enabling the retailers to follow competition intently and tune savings in accordance to competitor trends (including store brand items).

FIG. 2 is a diagram illustrating a scenario 200 for retail pricing based on ranking and order within a product linkage, according to an embodiment of a present subject matter. In an embodiment, a criteria for item profiling is defined. For example, the criteria includes performance metrics (KVI1-N), brand types (e.g., a national brand, a store band, and so on), size, and other attributes (e.g., form, color, sensitivity and so on). In an example, trend setting items (trending items) are identified as key items (7 items are selected as shown in FIG. 2) based on performance metrics (i.e., KVIs). Further, the key items are ranked (e.g., ranking 1-7 is given to items as shown in FIG. 2) based on the defined criteria. Also, business rules for linkage based retail recommendation are defined. In this example, similarities in attributes amongst items are leveraged to efficiently cover the network, by selectively pricing key items. Example rules are as follows:
1. KVI2 cannot drive KVI1 (e.g., a lower ranked KVI cannot drive a high ranked KVI)
2. KVI2 can drive KVI2, and similarly for other lower levels.
3. When overlap of defined savings does not exist, then the savings recommended by a higher ranked item wins over a lower ranked item.
4. when two items in a linkage both have a competitive capture and
   (a) The items are linked by the UOM, then priority will be given to the competitive capture and savings is adjusted accordingly.
   (b) The items are linked by the brand type, then
      (i) If one of the two items is non-KVI or a lower tier KVI, then retail is recommended based on savings.
      (ii) If both items are KVI items and have elasticity driven retail recommendation by the competitor Strategy:
         The retail price recommendation differs based on the elasticity and direction of competitor item change as shown in an example table below.

| | Competitor ↑ | Competitor ↓ |
|---|---|---|
| Elastic | ↑ if GAP > CAP(%/$) | Follow Competition |
| InElastic | Follow Competition | ↓ if GAP > CAP(%/$) |

As shown in FIG. 2, rank 1 item, rank 2 item and rank 4 item are the triggered items. Retail price recommendation is then provided to all the items in the linkage based on linked items. Further, the items are linked as mentioned below:
(i) rank 6 item, rank 2 item and rank 4 item are linked to rank 1 item,
(ii) rank 1 item and rank 3 item are linked to rank 2 item,
(iii) rank 2 item, rank 5 item and rank 7 item are linked to rank 3 item,
(iv) rank 1 item and rank 5 item are linked to rank 4 item,
(v) rank 3 item and rank 4 item are linked to rank 5 item,
(vi) rank 1 item and rank 7 item are linked to rank 6 item, and
(vii) rank 6 item and rank 3 item are linked to rank 7 item.

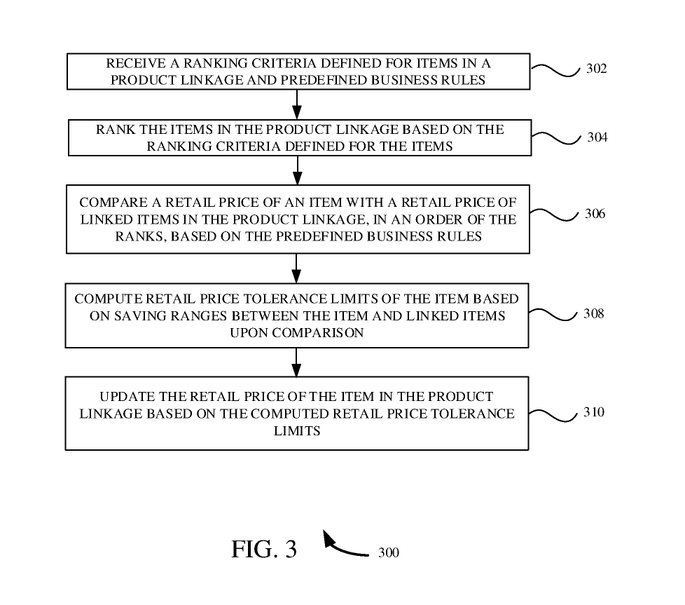

In an embodiment, for the rank 1 item, capture retail (competitor increase) which is maintained based on CAP percentage (%) defined for item is $1.99. For the rank 2 item, new retail is $3.29. Here, as shown in FIG. 3, new retail of the rank 2 item is beyond retail price tolerance limits ($3.59, $3.69) (computed based on savings (180%, 190%)) with the rank 1 item. For example, the tolerance limits are computed using the retail price of the rank 1 item and savings between the rank 1 item and rank 2 item. Hence, rank 2 item size savings is updated to (165%, 175%). Further, new retail price (competitor increase) of the rank 4 (high elasticity) item is $1.99 (increased to maintain 20% gap from competition). Since the rank 4 is aligned based on elasticity rule, savings is adjusted to (95%, 105%) to be in-line with a calculated retail price of $1.99. Furthermore, current retail price for the rank 6 item is $1.29. The retail price for the rank 6 item is updated to $1.49 based on the item 1 retail price tolerance limits ($1.49, $1.69) as the retail price $1.29 is less than the minimum of the retail price tolerance limits. For example, the tolerance limits are computed using the retail price of the rank 1 item and savings between the rank 1 item and rank 6 item. Now, the rank 1 item is considered to be fully processed and to be in complete alignment with surrounding linked items.

Further, current retail price of the rank 3 item is $5.89. The retail price of the rank 3 item is updated to $5.99 based on the rank 2 item retail price and savings between the rank 2 item and rank 3 item. For example, retail price tolerance limits computed based on savings between the rank 2 item and rank 3 item is ($5.99, $6.19). Hence, the retail price of the rank 3 item is updated to minimum of the tolerance limits (i.e., $5.99). The rank 2 item is now considered to be fully processed and to be in complete alignment with surrounding linked items.

Furthermore, current retail of the rank 5 item is $4.99, rounded tolerance limit computed based on size savings between rank 4 item and rank 5 item is ($5.99, $6.39), and rounded tolerance limit computed based on brand savings between rank 3 item and rank 5 item is ($4.79, $5.39). Therefore, no overlapping size tolerance and current retail price is already within brand tolerance limit. Hence, the size tolerance savings is adjusted to (295%, 325%). Also, current retail of the rank 7 item is $4.79, rounded tolerance limit computed based on size savings between rank 6 item and rank 7 item ($4.39, $4.69) and rounded tolerance limit computed based on brand savings between rank 3 item and rank 7 item ($4.49, $5.09). Therefore, overlapping tolerance is (Max (min), Min (max)) ($4.49, $4.69). Hence, retail of the rank 7 item is aligned to $4.69. The rank 3 item is considered to be fully processed and to be in complete alignment with surrounding linked items. Also, the rank 4 item, rank 5 item, rank 6 item, and rank 7 item are considered to be fully processed and to be in complete alignment with surrounding linked items.

In this embodiment, the tolerance limits are computed by rounding up the lower percentage savings to a nearest rounded price point and rounding down upper percentage savings to the nearest rounded price point. For example, retail price of item Y is $1.89 and the item Y is linked by a brank link with (110%, 130%) savings. Here, the rounded lower limit is $2.09 (unrounded is $2.07) and upper limit is $2.39 (unrounded is $2.46). Further, if the rounded upper limit is less than rounded lower limit, then perform reverse rounding i.e., round down (lower limit) and round up (upper Limit) in order to avoid the case of irresolvable tolerances. For example, retail price of item Z is $0.79 and the item Z is linked by a brank link with (77%, 86%) savings. Here, the rounded lower limit is $0.69 (unrounded is $0.61) and upper limit is $0.59 (unrounded is $0.68).

FIG. 3 illustrates a flow diagram of a method 300 for retail pricing within product linkages, in accordance with an example embodiment. The processor-implemented method 300 may be described in the general context of computer executable instructions. Generally, computer executable instructions can include routines, programs, objects, components, data structures, procedures, modules, functions, etc., that perform particular functions or implement particular abstract data types. The method 300 may also be practiced in a distributed computing environment where functions are performed by remote processing devices that are linked through a communication network. The order in which the method 300 is described is not intended to be construed as a limitation, and any number of the described method blocks can be combined in any order to implement the method 300, or an alternative method. Furthermore, the method 300 can be implemented in any suitable hardware, software, firmware, or combination thereof. In an embodiment, the method 300 depicted in the flow chart may be executed by a system, for example, the system 100 of FIG. 1.

At block 302, a ranking criteria defined for items in a product linkage and predefined business rules are received. For example, the product linkage includes a set of items linked (brand or unit of measure (UOM) linked) to each other. At block 304, the items in the product linkage are ranked based on the ranking criteria defined for the items. At block 306, a retail price of an item is compared with a retail price of linked items in the product linkage, in an order of the ranks, based on the predefined business rules. At block 308, retail price tolerance limits of the item are computed based on saving ranges between the item and linked items upon comparison. At block 310, the retail price of the item in the product linkage is updated based on the computed retail price tolerance limits.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

It is, however to be understood that the scope of the protection is extended to such a program and in addition to a computer-readable means having a message therein; such non-transitory computer-readable storage means contain program-code means for implementation of one or more steps of the method, when the program runs on a server or mobile device or any suitable programmable device. The hardware device can be any kind of device which can be programmed including e.g. any kind of computer like a server or a personal computer, or the like, or any combination thereof. The device may also include means which could be e.g. hardware means like e.g. an application-specific integrated circuit (ASIC), a field-programmable gate array (FPGA), or a combination of hardware and software means, e.g. an ASIC and an FPGA, or at least one microprocessor and at least one memory with software modules located therein. Thus, the means can include both hardware means and software means. The method embodiments described herein could be implemented in hardware and software. The device may also include software means. Alternatively, the embodiments may be implemented on different hardware devices, e.g. using a plurality of CPUs.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The foregoing description of the specific implementations and embodiments will so fully reveal the general nature of the implementations and embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The preceding description has been presented with reference to various embodiments. Persons having ordinary skill in the art and technology to which this application pertains will appreciate that alterations and changes in the described structures and methods of operation can be practiced without meaningfully departing from the principle, spirit and scope.

1. A processor-implemented method, comprising:
receiving, by one or more hardware processors, a ranking criteria defined for items in a product linkage and predefined business rules, wherein the product linkage comprises a set of items linked to each other;
ranking, by the one or more hardware processors, the items in the product linkage based on the ranking criteria defined for the items;
comparing, by the one or more hardware processors, a retail price of an item with a retail price of linked items in the product linkage, in an order of the ranks, based on the predefined business rules;
computing, by the one or more hardware processors, retail price tolerance limits of the item based on saving ranges between the item and linked items upon comparison; and
updating, by the one or more hardware processors, the retail price of the item in the product linkage based on the computed retail price tolerance limits.

2. The method of claim 1, wherein the ranking criteria comprises at least one of key value indicators, brand type, size, color, font and sensitivity.

3. The method of claim 1, wherein the saving ranges are recommended by at least one of a size link and a brand link between the item and linked items in the product linkage.

4. The method of claim 3, wherein updating the retail price of the item in the product linkage based on the computed retail price tolerance limits, comprises:
computing a first retail price tolerance limit between a size linked first item and second item and a second retail price tolerance limit between a brand linked second item and third item when the first item ranking drives retail changes to the second item, the second item is linked to the third item in a complimentary link, and the third item received a retail change; and

5. The method of claim 4, wherein the overlapping tolerance limit is obtained based on minimum and maximum values in the first retail price tolerance limit and second retail price tolerance limit.

6. The method of claim 3, further comprising:
updating at least one of saving ranges recommended by the size link and the brand link of an item when at least one of a retail price of the item is beyond associated retail price tolerance limits compared with associated linked items and the retail price of the item is a new retail price.

7. A system comprising:
one or more memories; and
one or more hardware processors, the one or more memories coupled to the one or more hardware processors, wherein the one or more hardware processors are capable of executing programmed instructions stored in the one or more memories to:
receive a ranking criteria defined for items in a product linkage and predefined business rules, wherein the product linkage comprises a set of items linked to each other;
rank the items in the product linkage based on the ranking criteria defined for the items;
compare a retail price of an item with a retail price of linked items in the product linkage, in an order of the ranks, based on the predefined business rules;
compute retail price tolerance limits of the item based on saving ranges between the item and linked items upon comparison; and
update the retail price of the item in the product linkage based on the computed retail price tolerance limits.

8. The system of claim 7, wherein the ranking criteria comprises at least one of key value indicators, brand type, size, color, font and sensitivity.

9. The system of claim 7, wherein the saving ranges are recommended by at least one of a size link and a brand link between the item and linked items in the product linkage.

10. The system of claim 9, wherein the one or more hardware processors are capable of executing programmed instructions to:
compute a first retail price tolerance limit between a size linked first item and second item and a second retail price tolerance limit between a brand linked second item and third item when the first item ranking drives retail changes to the second item, the second item is linked to the third item in a complimentary link, and the third item received a retail change; and
update a retail price of the second item based on an overlapping tolerance limit between first retail price tolerance limit and second retail price tolerance limit.

11. The system of claim 10, wherein the overlapping tolerance limit is obtained based on minimum and maximum values in the first retail price tolerance limit and second retail price tolerance limit.

12. The system of claim 9, wherein the one or more hardware processors are further capable of executing programmed instructions to:
update at least one of saving ranges recommended by the size link and the brand link of an item when at least one of a retail price of the item is beyond associated retail price tolerance limits compared with associated linked items and the retail price of the item is a new retail price.

13. One or more non-transitory computer readable information medium having embodied thereon a computer program for executing for activity detection from metadata features of e-mails, the method comprising of:
receiving, by one or more hardware processors, a ranking criteria defined for items in a product linkage and predefined business rules, wherein the product linkage comprises a set of items linked to each other;
ranking, by the one or more hardware processors, the items in the product linkage based on the ranking criteria defined for the items;
comparing, by the one or more hardware processors, a retail price of an item with a retail price of linked items in the product linkage, in an order of the ranks, based on the predefined business rules;
computing, by the one or more hardware processors, retail price tolerance limits of the item based on saving ranges between the item and linked items upon comparison; and
updating, by the one or more hardware processors, the retail price of the item in the product linkage based on the computed retail price tolerance limits.
